(19) United States
(12) Patent Application Publication
(10) Pub. No.: US 2009/0143878 A1
(43) Pub. Date: Jun. 4, 2009

(54) OPERATOR PROFILE CONTROL SYSTEM FOR A MACHINE

(75) Inventors: Michael D. Staub, Metamora, IL (US); Aaron M. Donnelli, Metamora, IL (US); Anthony D. McNealy, Peoria, IL (US); Alan L. Ferguson, San Jose, CA (US); Gary L. Spadin, Chillicothe, IL (US); Steven W. O'Neal, Bartonville, IL (US); Robert A. Horkavi, Dunlap, IL (US)

Correspondence Address: Caterpillar Inc.;Intellectual Property Dept., AH 9510, 100 N.E. Adams Street, PEORIA, IL, 61629-9510, US

(73) Assignee: CATERPILLAR INC., Peoria, IL (US)

(21) Appl. No.: 11/950,087

(22) Filed: Dec. 4, 2007

(51) Int. Cl. G05B 15/00; G06F 7/00

(52) U.S. Cl. 700/83; 701/36

(57) ABSTRACT

A control system for a machine has an input device operable to receive an input indicative of an operator profile and to generate a signal related to the operator profile. The control system also has a controller in communication with the machine and the input device. The controller is configured to receive the signal and to change at least one operating parameter of the machine in response to the signal.

### TECHNICAL FIELD

The present disclosure relates generally to a control system for a machine, and more particularly, to a control system for a machine that is linked to an operator profile.

### BACKGROUND

Machines such as, for example, wheel loaders, track type tractors, articulated trucks, excavators, and other types of machinery are used for a variety of tasks. These machines may be capable of producing substantial amounts of speed and torque with ground-engaging traction devices and/or with various implements. Operation of these machines may be complex and may require highly skilled operators to utilize the machine's full capabilities. However, there may be instances when the full capabilities of the machine are not required and/or not desired.

When the full capabilities of the machine are not required, operation of the machine by a highly skilled operator may be inefficient. For example, regular maintenance of a machine may only require operation of a machine's power source, without any required movement of implements or the machine. In addition, transportation of the machine to or from a work site may not require the full capabilities of the machine. During these situations, an operator with a lower skill level may efficiently operate the machine.

In addition, it may be desirous to limit the full capabilities of the machine in order to protect the machine against misuse or abuse by an operator with a lower skill level, and/or for safety reasons. For example, a maintenance technician, trainee, or lessee of rental equipment may not have the skills to safely operate the machine when the machine's full capabilities are available. In these circumstances, it may be desirous to limit the available machine capabilities to a lower output level controllable by an operator having a lower skill level.

One effort to selectively control machine operation is described in U.S. Pat. No. 6,522,251 (the '251 patent) issued to Menne et al. on Feb. 18, 2003. The '251 patent describes a machine security system interacting with a starter to start an engine of a machine in response to an identification code. The identification code may be given to an operator who has rented the machine, thereby giving the operator access to the machine for a period of time or during a particular time of day. Different identification codes may be given to different operators, allowing them different access times or time periods.

Although the machine security system of the '251 patent may restrict a particular operator from using a machine during a particular period of time or during a particular time of day, the machine security system does not change the output of the machine in response to the operator's profile. An unskilled operator may still have access to the full capabilities of the machine during his/her accessible time.

The disclosed system is directed to overcoming one or more of the problems set forth above.

### SUMMARY

In one aspect, the present disclosure is directed to a control system for a machine. The control system may include a server remotely located from and in communication with the machine and a controller located on the machine and in communication with the server. The server may include an operator profile input device and an operator profile database. The controller may be configured to receive an operator profile from the server and responsively change at least one machine operating parameter.

In another aspect, the present disclosure is directed to a method of controlling a machine operation. The method may comprise receiving an operator profile from an operator profile database in a remote server and changing at least one machine operating parameter in response to the operator profile.

In yet another aspect, the present disclosure is directed to a control system for a machine. The control system may include a remote server having a database with at least one stored operator profile, a transmitter connected to the server, and a controller located on the machine. The controller may include a receiver in communication with the transmitter and an input device operable to receive an operator input. The controller may be configured to compare the operator input and a corresponding stored operator profile and generate an associated machine control signal operable to change at least one machine operating parameter.

### BRIEF DESCRIPTION OF THE DRAWINGS

FIG. 1 is a schematic illustration of a control system according to one embodiment of the present disclosure.

### DETAILED DESCRIPTION

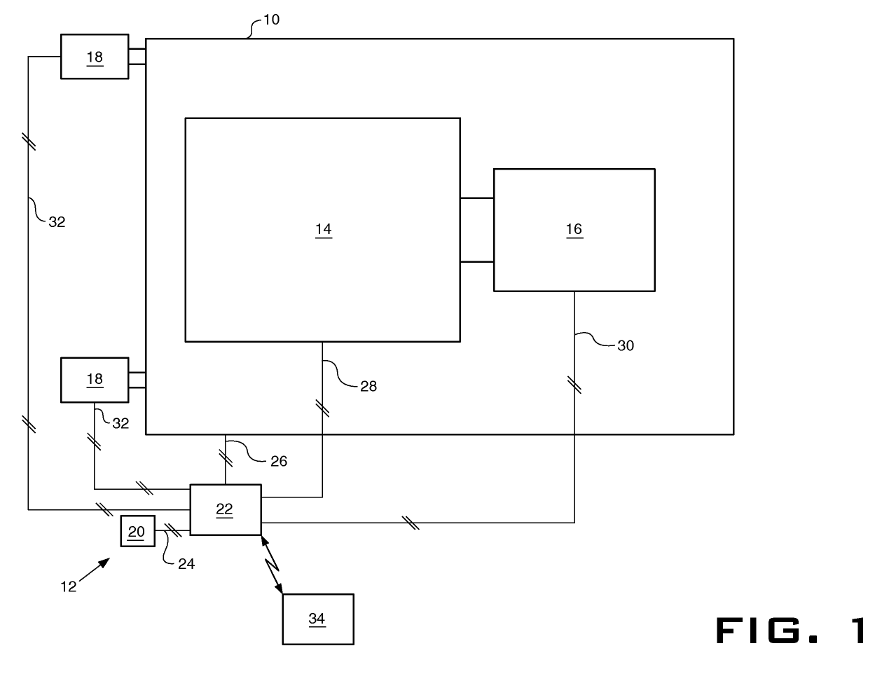

FIG. 1 illustrates a machine 10 having an exemplary embodiment of a control system 12 disposed on machine 10. Machine 10 may be a fixed or mobile machine that performs some type of operation associated with an industry such as mining, construction, farming, manufacturing, or any other industry known in the art. For example, machine 10 may be an earth moving machine, a generator set, a pump, a marine vessel, an aircraft, or any other suitable operation-performing machine. Machine 10 may include a power source 14 operatively connected to a transmission 16 and may also include a plurality of implements 18.

Power source 14 may be configured to produce a power output at a range of output speeds and torques. Power source 14 may be an engine such as, for example, a diesel engine, a gasoline engine, a natural gas engine, or any other suitable engine. Power source 14 may also be another source of power such as, for example, a fuel cell, a power storage device, or any other source of power known in the art.

Transmission 16 may be configured to transmit power from power source 14 to an output device (not shown) at a range of output speed ratios. Transmission 16 may be a hydraulic transmission, a mechanical transmission, a hydro-mechanical transmission, an electric transmission, or any other suitable transmission. The output device may include such devices as a ground engaging device, a pump, a generator, a propeller, or any other output device known in the art. It is also contemplated that transmission 16 may transmit power from power source 14 to the output device at only one output speed ratio.

Implements 18 may be operatively connected to machine 10 in any manner such as, for example, via a hydraulic circuit (not shown), via an electronic circuit (not shown), directly to power source 14 or transmission 16, or in any other suitable manner. Implements 18 may include such devices as a bucket, a shovel, a blade, a ripper, a claw, a power take off device, or any other suitable device. Implements 18 may be manually controlled by an operator to perform a desired function, or, alternately, may be automatically operated by machine 10.

Control system 12 may be in communication with machine 10, power source 14, transmission 16, and implements 18. Control system 12 may include an input device 20, a remote server 34, and a controller 22.

The input device 20 may include a means for receiving a code and generating a signal indicative of the code such as, for example, a keypad allowing the code to be manually entered by an operator, a switch configured to receive a coded key, or key card, having magnetic information on the key or a memory chip, a data port allowing direct communication with a service tool or a computer having the code, an antenna allowing reception of the code from a remote location, a bio-metric device configured to recognizing an operator based on a physiological or behavioral characteristic, a combination of factors such as those mentioned above and the like, or any other configuration that can receive the code and generate a signal in response to the code. A code, for the purposes of the present disclosure, may include a configuration of letters, numbers, symbols, pulses, voltage levels, bar codes, signals, magnetic fields, sound or light waves, and other configurations that represent an assigned meaning. The code may take the form of one or more of human readable information and machine-readable information. Input device 20 may be in communication with controller 22 via communication line 24.

Controller 22 may be configured to receive the signal generated by the input device 20 and/or a signal generated by the remote server 34. The controller 22 may be configured to change an operating parameter of the machine 10 or limit operation of the machine 10 in response to the signals from the input device 20 and/or the remote server 34. Controller 22 may be in communication with machine 10, power source 14, transmission 16, and implements 18, via communication lines 26, 28, 30, and 32, respectively. Controller 22 may include any means for controlling operating parameters of machine 10 such as, for example, a memory, one or more data storage devices, a central processing unit, or any other components that may be used to run an application. Furthermore, although aspects of the present disclosure may be described as being stored in memory, one skilled in the art will appreciate that these aspects can be stored on or read from other types of computer program products or computer-readable media, such as computer chips and secondary storage devices, including hard disks, floppy disks, optical media, CD-ROM, or other forms of RAM or ROM. Controller 22 may also include components such as, for example, mechanical or hydro-mechanical devices. Various other known circuits may be associated with controller 22 such as, for example, power supply circuitry, signal-conditioning circuitry, solenoid driver circuitry, communication circuitry, and other appropriate circuitry.

The remote server 34 may wirelessly connect and exchange signals with the control system 12 via the input device 20 or the controller 22 directly, depending on the configuration of the control system 12. The wireless connection may be achieved via any one of a number of ways known in the art, such as through radio frequency (RF) transmissions, cellular based communications, satellite based communications, and the like. The remote server 34 may be configured to store data such as machine data and operator profile in a database associated with the remote server 34. The remote server 34 may also include an input device (not shown) for inputting new operator profiles and updating current operator profiles stored on the remote server 34.

The remote server 34 may also include scheduling capabilities such that that it may store effective date/time information for operators and machines. The effective date/time may be based on an update of the operator profile data or machine data, at the start of an operator shift, at predetermined times of the day, and the like. The effective dates/times may also be scheduled to occur as machines 10 require maintenance, reach the end of a lease period, are identified as stolen, and the like. The controller 22 may also be configured to request an update from the remote server 34 if an unauthorized or unidentified operator tries to operate the machine 10.

For example, the remote server 34 may transmit operator profile data at the beginning of the effective date/time to be received by the input device 20 or controller 22 that would allow certain machines 10 to be operated or certain operations to be performed by specific operators at or during specific times. Alternatively, the remote server 34 may transmit operator profile data that may prevent certain machines 10 from being operated or prevent certain operations from being performed by unauthorized operators.

### INDUSTRIAL APPLICABILITY

The disclosed control system may be applicable to any machine 10 where it is advantageous to control parameters of the machine 10 based on an operator profile. Controlling parameters of the machine 10 based on operator profile may add a level of protection for the machine 10 and/or operator by limiting operation of equipment that may require a different skill level than what is possessed by the operator and/or unauthorized operation of the machine 10. Controlling parameters of the machine 10 based on operator profile may also allow for increased customization of services offered to a lessee of rental equipment by only allowing and only charging for access to specific machine capabilities desired by the lessee.

As explained above, different machine operators may have different levels of skill in operating various machines 10. For example, a lessee of rental equipment or a trainee may have little or no experience or skill operating the machine 10. A service technician may have some experience operating the machine 10. This experience, however, may be limited to operation of only portions of the machine 10, such as a power source or an implement 18 of the machine 10. Similarly, a transportation technician may skillfully drive a machine 10 at low speeds, in a particular direction, and/or for short distances during loading and unloading operations. It is unlikely that the lessee, the service technician, or the transportation technician individually possesses sufficient skill to operate all of the functions of the machine 10. In contrast, however, an operator with the responsibility of continuously operating all functions of the machine 10 on a regular basis may have a very high skill level.

Controlling parameters of a machine 10 based on operator profile may include limiting operation of a machine 10 within machine limits, power source output limits, transmission output limits, implement limits, time of day or time duration limits, or other appropriate limits that correspond with the operator's experience, skill level, and/or other profile-based factors. For example, the lessee may be limited in all areas of machine usage because of a low level of experience and/or skill. Likewise, the service technician may be limited to operating only the power source or the implement 18 for which the technician has been trained to service. Similarly, the transportation technician may be blocked from operating any implements 18 and may be limited to minimal travel speed and specified directions. In contrast, however, certain skilled operators may be granted full access to all machine functions.

The machine 10 may also have various automated machine functions that may control operation of the machine 10 with respect to power output, transmission output, and implement control. Certain of these automated functions may even require the appropriate training and/or certification before the operator is qualified to use that automated machine function. Once a training level and/or a certification is achieved, the operator profile may be updated to allow that certified operator to perform that automated machine function. For example, the machine 10 may have an automated grade control feature that may incorporate GPS or laser equipment to help achieve a certain soil grade and require a certain level of training with that equipment to operate. Alternatively, other automated machine functions may be required to remain on until the operator has met a requisite level of training on that particular machine 10. For example, the machine 10 may have an automated ride control feature that helps stabilize the machine 10 over rough terrain that remains operational until the operator has met the requisite training or logged enough hours on the machine 10 to disable the feature. The applicable training and/or certifications may be maintained as a component of the appropriate operator profiles.

As an additional possibility, a lessee only desiring to use a particular implement, function, and/or feature of the machine 10 may be assigned an operator profile that limits or blocks access to controls of other implements 18, functions, and features of the machine 10. In this manner, the implements 18, functions, and features not accessible to the customer may sustain less wear and require less maintenance. The lower levels of wear and maintenance may allow rental equipment to be rented for a lower cost, thereby providing increased customization for the lessee.

The lessor may also wish to limit the use of a machine 10 at the termination of the lease. The expiration date/time of the lease may be entered into a remote server 34 along with an operator profile restricting all or most of the functions and features of the machine. This profile will be sent by the remote server 34 to the control system 12 of the machine 10 at the date/time indicated. In this manner, the lessor of the machine 10 may automatically limit the functionality and features of a leased machine 10.

An operator profile and associated machine accessibility may be created by a manager of a construction company, a foreman of a construction site, a rental store employee, a manufacturer of the machine or any other entity with suitable authority. The operator profile may be based on attributes relating to an operator's experience level, an operator's skill level, an operator's physical ability level, a purchased access level, or any other suitable indicators on which an access level determination to functions of machine 10 may be based.

Controller 22 may include lists, lookup tables, or other data structures for storing access rights and limitation configurations on a memory of controller 22 that correspond to predetermined profiles. Controller 22 may be configured to change operating parameters of machine 10 such that the operating parameters fall within predetermined ranges related to the predetermined profiles. These profiles may be determined according to different types of operator groups. It is also contemplated that each operator may be assigned a unique profile corresponding to a particular arrangement of access rights and limitation configurations specific to the particular operator.

After establishing a profile for an operator that is representative of an experience level, skill level, physical ability level, and/or purchased access level of the operator, a code may be generated corresponding to the profile. This code may be entered into input device 20 in a variety of ways, depending on the configuration of input device 20. For example, input device 20 may include a keypad, the code being given to an operator in the form of letters, numbers, or a combination of both to be manually entered into control system 12. Alternately, input device 20 may include a switch such as an ignition switch or a dedicated switch, the code being delivered to control system 12 by means of a magnetic strip or a memory chip encoded and imbedded in a key given to an operator. Input device 20 may also include a scanner configured to read a barcode or other suitable encoded indicia. Input device 20 may also include a bio-metric device for recognizing an operator based on a physiological or behavioral characteristic. Input device 20 may also receive a signal, such as an RF signal, representing an operator profile from a remote server 34. Input device 20 may also deliver the code to control system 12 via a data port, an antenna, or any other means known in the art. The particular code entered into input device 20 may be transferred through control system 12 of machine 10 as a signal received by controller 22. Controller 22 may also receive the code directly as signal from a remote server 34. Controller 22 may then grant or deny access to particular implements 18, functions and/or features of machine 10 depending on the profile established for the particular operator.

Controller 22 may be in communication with various components of machine 10, power source 14, and transmission 16 such as, for example, speed sensors, load sensors, travel direction sensors, implement range sensors, implement force sensors, implement and transmission pressure sensors, fuel maps air induction maps, timing maps, fuel injectors, hydraulic pumps, motors, actuators, ignition switches, and other appropriate components. Controller 22 may be configured to change appropriate operating parameters of these components in response to the signal from input device 20 indicative of an operator profile and the signals from various sensors that enable controller 22 to assess the operating parameters of machine 10. Using this information, controller 22 may limit implement motion and/or machine output, power source output, and/or transmission output, and the like.

Machine output limits may include, among other things, a maximum travel speed, a maximum travel acceleration, a maximum rimpull torque, a maximum payload, a travel direction, or other machine output limits known in the art. Maximum travel speed, acceleration, and rimpull torque may be limited by, for example, controlling an associated maximum throttle setting, an injection timing, an air induction characteristic, a hydraulic pressure in a transmission of the machine 10, a speed command to transmission 16 of machine 10, or other suitable parameters. Maximum payload may be limited by limiting a hydraulic pressure in a implement 18, by restricting movement of machine 10 when loaded above a predetermined load limit, or by controlling other parameters known in the art. Travel direction may be limited by reducing maneuverability of a steering mechanism or by reducing selectability of transmission rotational directions.

Power source output limits may include, for example, a maximum power source speed, a maximum power source torque, a maximum power source acceleration, a maximum current and/or voltage output, or other appropriate power source limitations. These limits may be controlled by limiting an associated maximum fuel setting, an injection timing, an air induction characteristic, a number of firing cylinders, or in other ways known in the art.

Transmission output limits may include, among other things, a maximum output speed of transmission 16 of machine 10 or other transmission limitations known in the art. The output speed of transmission 16 may be limited by controlling a maximum speed command, a current or hydraulic pressure directed to a motor, a maximum pump or motor displacement, a maximum selectable speed ratio, or in other ways known in the art.

Implement limits may include, for example, acceleration limits, speed limits, force limits, range of motion limits, or limits to particular implements 18. The acceleration, speed, and force limits may be established by controlling a maximum hydraulic pressure to an actuator, a maximum pump flow rate, a maximum implement displacement distance, a maximum voltage to an actuator, a maximum control mechanism motion, or in other suitable ways. Access to particular implements 18 may be limited by preventing a current or pressure from being supplied to implements 18.

It will be apparent to those skilled in the art that various modifications and variations can be made to the disclosed control system without departing from the scope of the disclosure. Other embodiments will be apparent to those skilled in the art from consideration of the specification. For example, in the situation when the operator profile indicates the operator having a low skill level, the corresponding code supplied to the operator may be configured to invoke a training program, which may or may not require completion by the operator before expanding machine and/or implement functions, features, and/or accessibility. It is intended that the specification and examples be considered as exemplary only, with a true scope of the disclosure being indicated by the following claims and their equivalents.

What is claimed is:

1. A control system for a machine, comprising:
a server remotely located from and in communication with the machine, the server including:
an operator profile input device; and
an operator profile database; and
a controller located on the machine and in communication with the server, the controller configured to receive an operator profile from the server and responsively change at least one machine operating parameter.

2. The control system of claim 1, wherein the server is configured to generate a machine control signal based on the operator profile and the controller is configured to further receive a machine control signal from the server and responsively change the at least one machine operating parameter.

3. The control system of claim 1, wherein the controller is further configured to generate a machine control signal based on the operator profile and responsively change the at least one machine operating parameter.

4. The control system of claim 2, wherein the operator profile database includes one or more sets of machine control parameters associated with at least one stored operator profile, and the machine control signal is generated by locating the stored operator profile corresponding to an operator profile input and accessing the one or more sets of machine control parameters associated with the located, stored operator profile.

5. The control system of claim 1, further including:
a machine input device operable to receive an operator input and generate a machine control signal to change the at least one machine operating parameter.

6. The control system of claim 5, wherein the machine input device includes a keypad, card reader, scanner, or bio-metric device.

7. The control system of claim 1, wherein the operator profile is related to at least one of a purchased access level, a skill level, an experience level, or a physical ability of an operator of the machine.

8. The control system of claim 7, wherein the operator profile is updated when at least one of the at least one of the purchased access level, the skill level, the experience level, or the physical ability of an operator is changed; and
the controller responsively changes the at least one operator parameter.

9. The control system of claim 1, wherein the at least one operating parameter includes at least one of a machine travel speed limit, a machine travel acceleration limit, a machine torque level limit, a machine implement limit, an automated machine function, or a machine travel direction limit.

10. The control system of claim 1, wherein the machine includes at least one of a power source, a transmission, and an implement in communication with the controller, and the at least one operating parameter includes at least one of a power sources output limit, a transmission output limit, an automated machine function, or an implement limit.

11. The control system of claim 1, wherein the server further includes:
a scheduling module, the scheduling module configured to update the operator profile at a predetermined time; and
the controller configured to receive the updated operator profile from the server and responsively change the at least one machine operating parameter.

12. The control system of claim 1, wherein the server is wirelessly connected to the machine.

13. A method of controlling a machine operation, comprising:
receiving an operator profile from an operator profile database in a remote server; and
changing at least one machine operating parameter in response to the operator profile.

14. The method of claim 13, further including:
generating in the remote server a machine control signal based on the operator profile;
receiving the machine control signal from the remote server; and
responsively changing the at least one machine operating parameter.

15. The method of claim 13, further including:
generating on the machine a machine control signal based on the operator profile; and
responsively changing the at least one machine operating parameter.

16. The method of claim 13, wherein the at least one machine operating parameter includes at least one of a machine travel speed limit, a machine travel acceleration limit, a machine torque level limit, a machine implement limit, an automated machine function, or a machine travel direction limit.

17. The method of claim 13, further including:
receiving an operator input from the machine;
comparing the operator input with the operator profiles stored in the operator profile database;
accessing one or more sets of machine control parameters associated with the operator profile; and
changing the at least one machine operating parameter according to the associated machine control parameters.

18. The method of claim 13, wherein the operator profile is related to at least one of a purchased access level, a skill level, an experience level, or a physical ability of an operator.

19. The method of claim 18, further including:
updating the operator profile and the machine control signal as at least one of the purchased access level, the skill level, the experience level, or the physical ability of an operator changes;
communicating the updated machine control signal to the receiver; and
changing the at least one machine operating parameter in response to the updated machine control signal.

20. The method of claim 13, wherein changing the at least one machine operating parameter of the machine includes changing at least one of a power source output limit, transmission output limit, an implement limit, or an automated machine function.

21. The method of claim 13, further including:
updating the operator profile at a predetermined time; and
responsively changing the at least one machine operating parameter.

22. A control system for a machine, comprising:
a remote server having a database with at least one stored operator profile;
a transmitter connected to the server; and
a controller located on the machine and including:
a receiver in communication with the transmitter; and
an input device operable to receive an operator input;
the controller configured to compare the operator input and a corresponding stored operator profile and generate an associated machine control signal operable to change at least one machine operating parameter.

23. The control system of claim 22, wherein the database includes one or more sets of machine control parameters associated with the at least one stored operator profile, and the machine control signal is generated by locating the stored operator profile corresponding to the operator input and accessing the one or more sets of machine control parameters associated with the located, stored operator profile.

24. The control system of claim 22, wherein the stored operator profile is related to at least one of a purchased access level, a skill level, an experience level, or a physical ability of the operator of the machine.

25. The control system of claim 22, wherein the at least one machine operating parameter includes at least one of a machine travel speed limit, a machine travel acceleration limit, a machine torque level limit, a machine implement limit, an automated machine function, or a machine travel direction limit.
